(19) United States
(12) Patent Application Publication
(10) Pub. No.: US 2014/0293624 A1
(43) Pub. Date: Oct. 2, 2014

(54) LED LAMP HEAT DISSIPATION STRUCTURE

(71) Applicant: XIAMEN DONGLIN ELECTRONICS CO., LTD., Xiamen City (CN)

(72) Inventor: Runlin He, Xiamen City (CN)

(21) Appl. No.: 14/348,872

(22) PCT Filed: Jul. 13, 2012
(86) PCT No.: PCT/CN2012/078590

§ 371 Date: Mar. 31, 2014

(30) Foreign Application Priority Data
Oct. 11, 2011 (CN) 201120384494.X

(51) Int. Cl. F21V 15/01; F21K 99/00

(52) U.S. Cl. CPC F21V 15/011; F21K 9/30
USPC 362/373

(57) ABSTRACT

An LED lamp heat dissipation structure includes a drive circuit installed on a lamp holder. A housing is fitted on an insulation inner sleeve to form a first air flow gap therebetween. Both the insulation inner sleeve and the housing are installed on the lamp holder. The housing is provided thereon with an air vent. An aluminum substrate is installed on the housing. A second air flow gap is formed between the aluminum substrate and the insulation inner sleeve. A LED lamp plate is installed on the aluminum substrate. A lamp cover covers the LED lamp plate. An air flow through hole is formed from the surface of the lamp cover to the aluminum substrate. The air flow through hole is in communication with the air flow gaps. The present invention has a very good heat dissipation effect and prolongs the service life of the entire lamp.

### BACKGROUND OF THE INVENTION

1. Field of the Invention

The present invention relates to an LED lamp, and more particularly to an LED lamp heat dissipation structure.

2. Description of the Prior Art

A conventional LED lamp comprises a lamp holder, a drive circuit, a heat dissipation member, an LED lamp plate, and a lamp cover. The drive circuit is installed in the lamp holder. The heat dissipation member and the LED lamp plate are installed on the lamp holder. The LED lamp plate is connected with the drive circuit and located in the lamp cover. The lamp cover is disposed above the heat dissipation member. When in use, the drive circuit controls the LEDs on the LED lamp plate to illuminate after electrified. The light penetrates through the lamp cover to provide an illumination effect.

However, when in use, the heat generated by the drive circuit and the LED lamp plate are dissipated by the dissipation member only. The dissipation effect is bad, which direct influences the service life of the entire lamp. Accordingly, the inventor of the present invention has devoted himself based on his many years of practical experiences to solve this problem.

### SUMMARY OF THE INVENTION

The primary object of the present invention is to provide an LED lamp heat dissipation structure which has a very good heat dissipation effect and prolongs the service life of the entire lamp

In order to achieve the aforesaid object, the LED lamp heat dissipation structure of the present invention comprises a lamp holder, a drive circuit, an insulation inner sleeve, a housing, an aluminum substrate, an LED lamp plate, and a lamp cover. The drive circuit is installed on the lamp holder. The housing is fitted on the insulation inner sleeve to form a first air flow gap therebetween. Both the insulation inner sleeve and the housing are installed on the lamp holder. The housing is provided thereon with an air vent. The aluminum substrate is installed on the housing. A second air flow gap is formed between the aluminum substrate and the insulation inner sleeve. The LED lamp plate is installed on the aluminum substrate and connected with the drive circuit. The lamp cover is adapted to cover the LED lamp plate. An air flow through hole is formed from the surface of the lamp cover to the aluminum substrate. The air flow through hole is in communication with the first and second air flow gaps.

Preferably, the aluminum substrate is formed with a central hole. The center of the surface of the lamp cover is concaved inward and extends to the central hole of the aluminum substrate.

Preferably, the aluminum substrate has a cone shape. The LED lamp plate is installed on the cone surface of the aluminum substrate. The top of the insulation inner sleeve is formed with a spherical surface to match with the cone surface. The second air flow gap is formed between the spherical surface and the cone surface.

Preferably, the aluminum substrate has a flat shape. The LED lamp plate is installed on a flat surface of the aluminum substrate. The top of the insulation inner sleeve is formed with a curved surface to match with the flat surface. The second air flow gap is formed between the curved surface and the flat surface.

The air vent, the two air flow gaps, and the air flow through hole of the present invention form a heat dissipation channel. When in use, the heat generated by the drive circuit and the LED lamp plate can be dissipated timely through the heat dissipation channel. Thus, the present invention has a very good heat dissipation effect and prolongs the service life of the entire lamp.

### BRIEF DESCRIPTION OF THE DRAWINGS

FIG. 1 is a sectional view according to a first embodiment of the present invention; and

FIG. 2 is a sectional view according to a second embodiment of the present invention.

### DETAILED DESCRIPTION OF THE PREFERRED EMBODIMENTS

Embodiments of the present invention will now be described, by way of example only, with reference to the accompanying drawings.

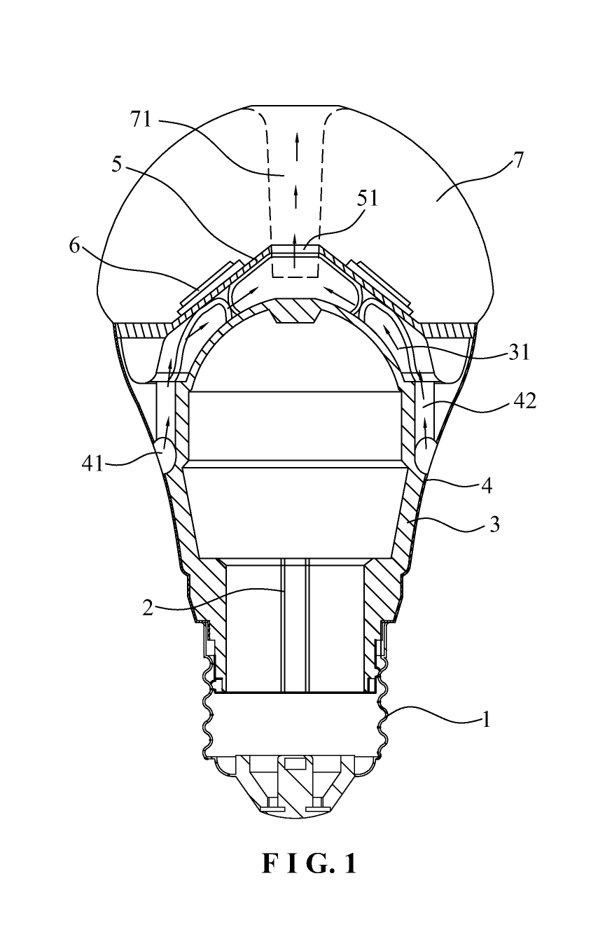

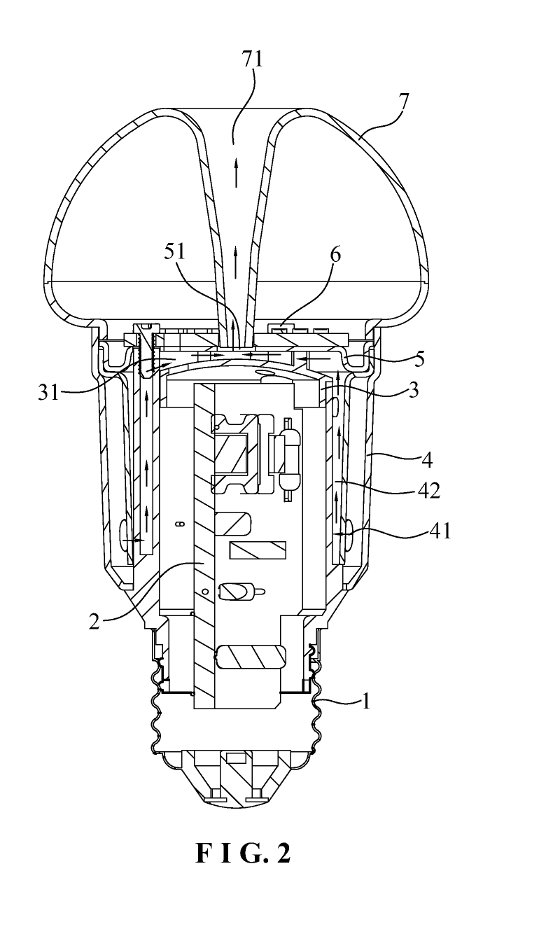

As shown in FIG. 1 and FIG. 2, the present invention discloses an LED lamp heat dissipation structure which comprises a lamp holder 1, a drive circuit 2, an insulation inner sleeve 3, a housing 4, an aluminum substrate 5, an LED lamp plate 6, and a lamp cover 7.

The lamp holder 1 is a connecting component for the entire lamp and the lamp base. The structure of the lamp holder 1 can be any one of the existing lamp holders.

The drive circuit 2 is an electronic component for controlling the entire lamp to illuminate, and is installed on the lamp holder 1. The structure of the drive circuit 2 can be any one of the existing drive circuits.

The insulation inner sleeve 3 is an insulation component for protecting the drive circuit 2. The housing 4 is a component for protecting the drive circuit 2 and the insulation inner sleeve 3 and supporting the entire lamp. The housing 4 is fitted on the insulation inner sleeve 3. Bothe the insulation inner sleeve 3 and the housing 4 are installed on the lamp holder 1. A first flow gap 42 is formed between the insulation inner sleeve 3 and the housing 4. The housing 4 is provided thereon with an air vent 41.

The aluminum substrate 5 is installed on the housing 4 for installing the LED lamp plate 6. A second air flow gap 31 is formed between the aluminum substrate 5 and the insulation inner sleeve 3.

The LED lamp plate 6 is an illuminating component of the entire lamp. The LED lamp plate 6 is installed on the aluminum substrate 5 and connected with the drive circuit 2.

The lamp cover 7 is adapted to cover the LED lamp plate 6. An air flow through hole 71 is formed from the surface of the lamp cover 7 to the aluminum substrate 5. The air flow through hole 71 is in communication with the first and second air flow gaps 42, 31. The structure can be in different configuration. As shown in FIG. 1 and FIG. 2, the aluminum substrate 5 is formed with a central hole 51. The center of the surface of the lamp cover 7 is concaved inward and extends to the central hole 51 of the aluminum substrate 5.

The aluminum substrate 5 can be in different shapes. The insulation inner sleeve 3 corresponds in shape to the aluminum substrate 5. For example, as shown in FIG. 1, the aluminum substrate 5 has a cone shape. The LED lamp plate 6 is installed on the cone surface of the aluminum substrate 5. The top of the insulation inner sleeve 3 is formed with a spherical surface to match with the cone surface. The second air flow gap 31 is formed between the spherical surface and the cone surface. As shown in FIG. 2, the aluminum substrate 5 has a flat shape. The LED lamp plate 6 is installed on the flat surface of the aluminum substrate 5. The top of the insulation inner sleeve 3 is formed with a curved surface to match with the flat surface. The second air flow gap 31 is formed between the curved surface and the flat surface.

The air vent 41, the two air flow gaps 31, 42, and the air flow through hole 71 of the present invention form a heat dissipation channel. When in use, the heat generated by the drive circuit 2 and the LED lamp plate 6 can be dissipated timely through the heat dissipation channel. Thus, the present invention has a very good heat dissipation effect and prolongs the service life of the entire lamp.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An LED lamp heat dissipation structure, comprising a lamp holder, a drive circuit, an insulation inner sleeve, a housing, an aluminum substrate, an LED lamp plate and a lamp cover, the drive circuit being installed on the lamp holder, the housing being fitted on the insulation inner sleeve to form a first air flow gap therebetween, the insulation inner sleeve and the housing being installed on the lamp holder, the housing being provided thereon with an air vent, the aluminum substrate being installed on the housing, a second air flow gap being formed between the aluminum substrate and the insulation inner sleeve, the LED lamp plate being installed on the aluminum substrate and connected with the drive circuit, the lamp cover being adapted to cover the LED lamp plate, an air flow through hole being formed from a surface of the lamp cover to the aluminum substrate, the air flow through hole being in communication with the first and second air flow gaps.

2. The LED lamp heat dissipation structure as claimed in claim 1, wherein the aluminum substrate is formed with a central hole, and a center of the surface of the lamp cover is concaved inward and extends to the central hole of the aluminum substrate.

3. The LED lamp heat dissipation structure as claimed in claim 1, wherein the aluminum substrate has a cone shape, the LED lamp plate is installed on a cone surface of the aluminum substrate, a top of the insulation inner sleeve is formed with a spherical surface to match with the cone surface, the second air flow gap is formed between the spherical surface and the cone surface.

4. The LED lamp heat dissipation structure as claimed in claim 1, wherein the aluminum substrate has a flat shape, the LED lamp plate is installed on a flat surface of the aluminum substrate, a top of the insulation inner sleeve is formed with a curved surface to match with the flat surface, and the second air flow gap is formed between the curved surface and the flat surface.
